(19) United States
(12) Patent Application Publication
(10) Pub. No.: US 2020/0211241 A1
(43) Pub. Date: Jul. 2, 2020

(54) METHOD AND SYSTEM FOR FACILITATING VISUALIZING DATA

(71) Applicant: Armand Prieditis, Arcata, CA (US)

(72) Inventor: Armand Prieditis, Arcata, CA (US)

(21) Appl. No.: 16/236,606

(22) Filed: Dec. 30, 2018

(51) Int. Cl. G06T 11/20; G06N 7/00

(52) U.S. Cl. CPC G06T 11/206; G06N 7/005

(57) ABSTRACT

One embodiment of the subject matter facilitates visualizing data by clustering a plurality of rows (i.e. the data), determining a distance between each row and each cluster, assigning the distance between each row and each cluster to a respective visual variable value (e.g. location, color, intensity, and time), and displaying the resulting visual variables in a visualization.

### INCORPORATION BY REFERENCE

The instant application hereby incorporates by reference non-provisional U.S. patent application Ser. No. 16/216,853.

### BACKGROUND

### Field

The subject matter relates generally to visualizing data.

### Related Art

It is estimated that over 2.5 quintillion bytes of data are created each day. Based on these estimates, 1.7 MB of data will be created every second for every person on earth by 2020. This data is not only high volume, but typically high-dimensional, which can make it difficult to comprehend. Visualization of the data can be important because it can reveal similarities, differences, patterns, outliers, and trends in the data that would otherwise be difficult for a human to comprehend. Human vision provides built-in comprehension of grouping by location, color, shape, intensity, shade, contrast, motion, direction, and stereoscopic depth.

Traditional methods of visualization that can produce such groupings include time series plots (where a single variable is plotted against time); line charts (which can show cycles and trends); bar charts or pie charts (where a single variable is compared across different categories); norms and deviation from norms; frequency distribution through histograms (counts or percentages of one, two or three variables for a given interval), boxplots showing statistics such as the mean, median, quartiles, min, max; outliers; correlations between two variables as shown through a scatterplot; and geospatial layouts using heatmaps, 3D surfaces, or color maps.

These techniques work well when just a few variables are involved, but they fail to scale up when a large number of variables are involved. This is because each variable is typically displayed alone or relative to only a few other variables. That is, these methods are unable to combine a large number of variables so that humans can visually comprehend them all in parallel.

Force-based layout methods can combine multiple variables by mapping each row in the data to a point in a one-, two-, or three-dimensional graph based on a distance matrix representation of the rows in the data. These methods first transform the data into the distance matrix, where an element for the i^{th} row and j^{th} column in the distance matrix corresponds to a distance between row i and row j in the data. Next, the points, which correspond to rows in the data, are placed on a graph so that distance between the points on the graph are as close as possible to the corresponding distances in the distance matrix. These methods can be useful to find clusters, discover connectors between clusters, and discover influencers and outliers.

Force-based layout suffers from several shortcomings. First, it requires a distance metric that can be used to determine the distance between rows. A distance metric can be difficult or impossible to develop for categorical (non-numerical) variables. Second, a distance metric can exaggerate the importance of a variable that has a large range. Third, force-based layout does not scale up as the number of rows grows. This is because the placement of any one row in the visualization requires a calculation over all other rows. That is, force-based layout's time and space complexity is quadratic in the number of rows.

Fourth, missing values in a row can arbitrarily reduce the distance metric if those missing values are ignored. That is, a row with many missing variable values can accidentally appear closer to other rows based on the distance metric.

Hence, what is needed is a data visualization method and system that can combine one or more variables (i.e., facilitates multi-dimensional data), that does not require a distance metric between rows, and that can handle categorical, numerical, and missing variables.

### SUMMARY

One embodiment of the subject matter facilitates visualizing data by clustering a plurality of rows (i.e. the data), determining a distance between each row and each cluster, assigning the distance between each row and each cluster to a respective visual variable value (e.g. location, color, intensity, and time), and displaying the resulting visual variable values in a graph, which can be animated over time.

Visual variables facilitate two fundamental aspects of data visualization: differences and similarities. Differences in visual variables can create the effect of differences in the data. Similarities in visual variables can create the effect of similarities in the data. This effect is created in the human eye/mind/brain.

Particular embodiments of the subject matter can be implemented so as to realize visualizing multi-dimensional data without requiring a distance metric between rows while handling categorical, numerical, and missing variable values.

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 shows an example system for facilitating visualizing data.

FIG. 2 presents a flow diagram of an example process for facilitating visualizing data.

In the figures, like reference numerals refer to the same figure elements.

### DETAILED DESCRIPTION

A visual variable, also called a visual attribute, corresponds to differences in displayed elements, as perceived by the human eye. A visual variable is a characteristic of a visual symbol, which is a way of representing an entity or idea in a visual form. A visual variable is therefore a part of a graphic vocabulary.

Visual variables include but are not limited to position or location (i.e., x, y, and z coordinates), time (which can yield animations and the appearance of movement, change, or rate of change), additive color (red, blue, green), subtractive color (cyan, yellow, magenta), HSL (hue, saturation, lightness), HSV (hue, saturation, value), color scale (rainbow, multi-hue, single-hue, viridis, magma, plasma, inferno, cividis, rainbow, head, ggplot default, brewer blues, brewer yellow-green-blue, green-blind scales, red-blind scales, blue-blind scales, desaturated scales, diverging, rgb scales, hsl scales, qualitative, diverging, sequential, k-color, APHA color, Choropleth map, Quality Scale, Color triangle, Color wheel, Fischer-Saller scale, Fitzpatrick scale, Forel-Ule scale, Gardner color scale, Heat map, Martin scale, Martin-Schultz scale, Pt/Co scale), size (length, width, height, area, volume), orientation (angle), shape, texture, focus (crispness: sharpness of boundaries), resolution (level of detail or precision), arrangement (spacing or distribution of individual marks that make up a point), perspective (3D) height, blink rate, spin rate, color change rate, speed, frequency, direction, rhythm, flicker, trails, and style. Thus, each of the visual variables has a value, which corresponds to a particular numerical level.

Embodiments of the subject matter can cluster a plurality of rows, determine a distance from each row to each cluster, assign each distance to a respective value of a visual variable, and display the resulting visual variables in a visualization such as a graph.

Embodiments of the subject matter can use a variety of clustering methods. A preferred embodiment can be based on Gaussian Mixtures or k-means clustering, both of whose parameters can be found with multiple random restarts with the Expectation-Maximization method. Once clustering is complete, the distance metric can be as follows:

$$d ( x , b , i ) = \frac{{( x - {μ}_{b , i} )}^{T} {\sum }_{b , i}^{- 1} ( x - {μ}_{b , i} ) + ln \vert {\sum }_{b , i} \vert}{2} - ln {p}_{i}$$

Here x is a column vector of values (i.e., the input from a row), b is a corresponding vector of variable identifiers of those values in x, i is an identifier for a particular cluster, μ_{b,i} is a corresponding column vector of most likely values for the variables identified by b for the i^{th} cluster, Σ_{b,i} is a covariance matrix for the variables identified by b for the i^{th} cluster, Σ_{b,i}⁻¹ is an inverse of the covariance matrix, |Σ_{b,i}| is a determinant of the covariance matrix, pᵢ, is a probability the i^{th} cluster, T is the transpose operator, and ln is the natural logarithm.

The column vector of values x comprises values of variables, where each element of x corresponds to the value associated with a particular column in the data, where the data is organized into a plurality of rows. Thus, a single column in the data corresponds to a plurality of values of a variable associated with that column. In particular, the vector x and corresponding vector b can arise from a particular row in the data.

The operator—is a vector minus operation whose element-wise operator—is a standard minus when its two corresponding elements are numerical. However, when its two corresponding elements are categorical, the result is still numerical but is based on a difference table associated with the categorical variable, indexed by each pair of categorical variable values as described in non-provisional U.S. patent application Ser. No. 16/216,853, which is incorporated by reference here.

Other methods can be used to approximate or determine pᵢ, μ_{b,i}, and Σ_{b,i}. For example, the inverse of the covariance matrix can be approximated directly. The probability pᵢ can be based on constants added to the numerator and denominator to avoid divide-by-zero errors or to include prior knowledge. The covariance matrix can have a small random value added to each element of the diagonal to prevent singularity.

Note that the covariance matrix can be diagonal, which simplifies the inversion to be the inverse of the diagonal entries. The covariance matrix can also be the identity matrix I, which facilitates simplifying the equation for d(x, b, i) to

$$\frac{{( x - {μ}_{b , i} )}^{T} ( x - {μ}_{b , i} )}{2} - ln {p}_{i} .$$

Each diagonal element of the identity matrix I is the multiplicative identity, which is defined as 1; each off diagonal element of the identity matrix I is the additive identity, which is defined as 0. If the prior probability pᵢ is ignored (i.e., set to 1), this equation can be further simplified to d(x, b, i)=(x−μ_{b,i})^{T}(x−μ_{b,i}). This latter simplification, which avoids an inversion at the cost of weighting all variable values equally, is employed in k-means clustering.

Embodiments of the subject matter can facilitate handling missing variables as follows. Those variables that are not missing are described in b, along with their corresponding values in x. That is, b contains the identifiers for those non-missing variable values, which are used to index into the mean vector and the covariance matrix. The remaining variables are assumed to be missing and are ignored. In a multivariate Gaussian, this property is known as marginalization and is equivalent to ignoring those variables. Hence, for purposes of the distance metric d(x,b,i), the missing variable can simply be ignored based on the theory of marginalization for Gaussians.

Embodiments of the subject matter facilitate normalization of the distance metric where the rows comprise differing numbers of missing variables. This normalization is because of the aforementioned marginalization. For example, one row might have three missing variable values and another row might have six missing variable values but both rows are normalized appropriately so that one row does not appear closer to a cluster than another row.

When the distance from each of these rows to a given cluster is determined as described above, the difference in the number of missing variable values is automatically normalized through the aforementioned marginalization-by-ignoring-missing-variables. That is, the row with the six missing variable values will not appear to be accidentally closer to the cluster than for the other row.

Note that embodiments of the subject matter do not require a distance metric between rows and can facilitate numerical, categorical, and missing variables while combining a plurality of variable values through unsupervised learning (clustering).

As an example, consider a plurality of rows that have been clustered into k clusters and for which any row with variable values x with corresponding variable identifiers b has an associated s(x,b,i) for the i^{th} cluster. This particular row will have k distance measures. For example, when k=4, this row might comprise distance measures 12.5, 200.54, 3.34, and 55.98 for clusters 1, 2, 3, and 4 respectively. These values can be assigned to x, y, and z positions and a Yellow-Orange-Red color scale as follows: x=12.5, y=200.54, z=3.34, and Yellow-Orange-Red scale=55.98.

All of the assigned values can be scaled to fit a particular target range based on the min and max values of the respective variables or the mean and standard deviations of the respective variables. For example, if the Yellow-Orange-Red scale goes from frequency f1 to frequency f2 and the range for the fourth cluster value across the plurality of data is from r1 to r2 then the multiplier for the cluster distance to the fourth cluster from unscaled value v can be can be (v−r1)(f2−f1)/(r2−r1). Other scaling methods can be used.

In this example, the distance to the first cluster is assigned to the x value, the distance to the second cluster is assigned to the y value, the distance to third cluster is assigned to the z value and the distance to the fourth cluster is assigned to the Yellow-Orange-Red scale. All of these values can be scaled to match the target values as described above or using some other method. This particular row is then displayed with the above x, y, z, and color scale values. Other rows can also be displayed in the same graph using the same assignment to the visual variables x, y, z and Yellow-Orange-Red scale.

Note that an appropriate number of clusters does not have to be determined for each application. That is, a fixed number of clusters can always be used for visualizing any set of data. For example, three positions (x, y, z), a color scale, and size as a visual variable can facilitate five dimensions of display. Instead of a color scale, RGB or CYM or Chroma-Value-Hue can each be used for three dimensions each (e.g. the distance to one cluster maps to Red, the distance to another cluster maps to Green, and the distance to a third cluster maps to Blue). These dimensions plus location and size can facilitate seven clusters. Embodiments of the subject matter can scale to any number of visual variables—one cluster distance is assigned one visual variable.

Typically, the number of clusters will be limited to the number of visual variables a human can comprehend in parallel, which is up to 30 separate visual variables. However, some visual variables are more important than others. Typically, the most important visual variables should be mapped to clusters first. These most important visual variables include x and y location, color, shape, area, length, width, angle, orientation, enclosure, and blur.

Three-dimensional position is not included in this list of the most important visual variables because humans do not perceive depth (the z coordinate) directly. Instead, humans use a combination of cues from other visual variables such as area (larger objects appear closer), occlusion (one object in front of another object is closer), and stereo vision (differences between the eyes). For this reason, depth is typically avoided in visualizations of data. Creating the appearance of depth through rotating point clouds can work reasonably well, however.

The visual variables can be ranked from the most important to the least important for human perception. For example, positional visual variables can be the most important ones and are typically followed by color and then size. Embodiments of the subject matter can assign a variable value to a visual variable value based on this order of visual importance. The ordering of variables can be based on the variance associated with the cluster distance. For example, those cluster distances with the lowest variances can be assigned to most visually important visual variables first. Here, the variance related to cluster distance is defined as the variance of the distance from a row to the cluster (as defined above), as determined over all the rows of the data.

A distance to a particular cluster can be associated with time as a visual variable. Time can also correspond to actual time in the data. In the latter case of time as actual time in the data, time can be excluded as a variable that is used in clustering. In either case, the visualization can be animated over time based on standard video/audio transport controls such as play, forward, reverse, fast-forward, fast-reverse, rewind, and pause.

The determination of d(x,b,i) can involve an inversion of the covariance matrix, which can require roughly O(n³) processing power, where n is the number of columns. Hence when the number of columns grows large, the complexity of clustering can exceed certain processing power. In such situations, embodiments of the subject matter can sample a plurality of columns, cluster each sample to determine the distance metric d(x,b,i) and then combine multiple such distance metrics by averaging them. These averages can then be mapped to visual variables and displayed as described above.

Applications of embodiments of the subject matter include customer and product maps, website connection maps, router connection maps, criminal network visualization, referral or shared-customer networks, fraud detection, social networks, word meaning analysis, and publication visualization.

Customer and product maps. Customers buy and sometimes rate products. These purchases and ratings form a vector, one for each customer: the purchases can be binary and the ratings can be numerical. The vectors for each customer can then be clustered as described above and then the customers can be visualized based on their purchases or ratings as described above. Such visualizations can facilitate marketers to better understand which customers are related, how customers can be segmented based on their purchases, see changes over time, and better determine which products could be co-marketed.

Note that a customer's row will typically have most columns missing because a customer will not have purchased or rated every product offered by a vendor. Embodiments of the subject matter do not require that a customer have purchased or rated all products. This is because embodiments of the subject matter can comprise Gaussian Mixture Models, which do not require that all rows have no missing variable values. That is, marginalization handles missing values in embodiments of the subject matter.

In contrast to recommendation systems, a customer's demographics (or more broadly characteristics) can be included as part of the vector. Moreover, these demographics can include categorical variables. The resulting visualization can reflect not only what products a customer has bought, but the customer's own demographics. Thus, similar customers in terms of both purchases and characteristics can appear near each other in a visualization.

As used herein, the term “characteristic” may include demographics characteristics such as gender, race, age, disabilities, mobility, income, home ownership, and employment status; personality characteristics; psychographics; interests; biases; likes; dislikes; values attitudes; interests; lifestyles, activities; opinions; tastes; usage rates; brand preference; and firmographics such as industry, seniority, functional area, behavioral variables, geographic location, and anything that can be used to characterize a user.

A “geographic location” or “geographic position” may be defined in terms of country/city/state/address, country code/zip code, political region, geographic region designations, latitude/longitude coordinates, spherical coordinates, Cartesian coordinates, polar coordinates, Global Positioning System (GPS) data, cell phone data, directional vectors, proximity waypoints, or any other type of geographic designation system for defining a geographical location or position.

Customers can also be visualized based on their journey: a vector can include purchases over a plurality of time intervals and these journeys can include other events such as phone contacts or web contacts.

A similar method to customer maps can be used to produce product maps for products, based on customers who have bought a product and possibly rated the product. Products can also include music, videos, books, all of which have their own characteristics as well as relations to individuals who purchased them.

Website connection maps. Similarly, websites can be clustered and displayed on a map in accordance with embodiments of the subject matter. In the case of websites, each row can correspond to a website and the columns correspond to websites pointing directly into the website or the number of hops from a website associated with the column to the website associated with the row. Each website can also have characteristics associated with it such as the content, bag of words, or topics. These characteristics can be combined with the relationships to other websites based on embodiments of the subject matter.

Router connection maps. Router network visualization can be treated similarly except that the connections between routers can be two-way and the geographic location of routers can be taken into account.

Criminal network visualization. Criminal network analysis can facilitate uncovering terrorist networks to improve public safety and national security. It has been acknowledged by the defense community that discovering the structure of terrorist networks and how those networks operate can be an important factor against terrorists.

The analysis of terrorist networks can be generalized to that of criminal networks, which can be applied to the analysis of organized crime such as for narcotics trafficking, fraud, and gangs. Networks arise in such crimes because crimes are typically carried out by a plurality of criminals who collaborate into networks. For example, in a narcotics network, different groups might supply drugs, distribute them, sell them, smuggle them, or launder money associated with the profits. Connecting all of these groups can lead to the detection and arrest of multiple offenders.

Intelligence and law enforcement agencies typically have too much data and too little understanding of it. For example, connections between individuals might include phone records, Twitter and Facebook reads, bank transfers, and vehicle sales between two individuals. The data can be organized into rows representing individuals, their characteristics, and connections to other individuals. Embodiments of the subject matter can then be used to visualize individuals and their networks so that relationships can emerged through these visual explanations.

Such visualizations can also facilitate determining subgroups that exist in criminal networks, how they interact with each other, who is at the center of such clusters, who are the major influencers, and what roles individuals play. Embodiments of the subject matter can automatically facilitate visualization of individuals to enable such operations. Moreover, such visualizations can be viewed over time to observe changes.

Centrality can be determined by measuring distance to the nearest cluster. Those individuals who are closest to the center can be viewed as central. Influence can be determined as those individuals who are closest to most clusters.

Referral or shared-customer networks. Referral networks can include networks related to sales or patients of physicians. Networks can also be developed based on shared customers or patients and similar analysis to criminal networks can be facilitated based on using embodiments of the subject matter.

Fraud detection. Outliers in networks can be viewed as anomalies, which in turn can be viewed as fraudulent individuals or organizations.

Social networks. Individuals in a social network can be visualized based on who follows the individual (i.e., the “in-links”) and characteristics of the individuals. Out-links (who the individual follows) can also be leveraged in these visualizations, though are more subject to manipulation. In either case, the rows in the social network can correspond to individuals or organizations and the columns can correspond to characteristics and relations between individuals and organizations.

Word meaning analysis. Embodiments of the subject matter can also be applied to visualizing words and their context. For example, each word can correspond to a row and the columns can correspond to whether or not a respective word co-occurs in the context of the same sentence, paragraph, page, document, book, or within a fixed number of words. The columns can also correspond to the distance away from a word to the word corresponding to the row within the aforementioned context. Words can then be visualized in their context based on embodiments of the subject matter. Words can also include characteristics such as synonyms, gender, plurality, part of speech, origins, language, antonyms, and generalizations.

Publication visualization. A publication such as a book, paper, or article can be cited by other publications. A publication can also be associated with certain characteristics (e.g., the words that occur in the publication and the subject matter). Embodiments of the subject matter can be used to produce visualizations of publications in their citation context as well as characteristics.

General-purpose characteristics plus relations. More generally, embodiments of the subject matter can be applied to situations where rows correspond to entities (objects or instances) in an ontology. Entities can include but are not limited to concrete objects such as people, animals, corporations, organizations, groups, cities, tables, products, books, automobiles, molecules, atoms, planets, solar systems, galaxies, as well as abstract individuals such as a row in a database, numbers, words, websites, servers, and machines.

These entities can comprise characteristics as well as relations to other entities of the same or different type. Characteristics can include classes of the entities (i.e, type, sort, category, and kind). Relations can also include aspects or parts of the same or different types of entities such as part-whole relationships. As described above, if the number of relations grows too large, those relations can be sampled and then combined after clustering each set of relations by averaging.

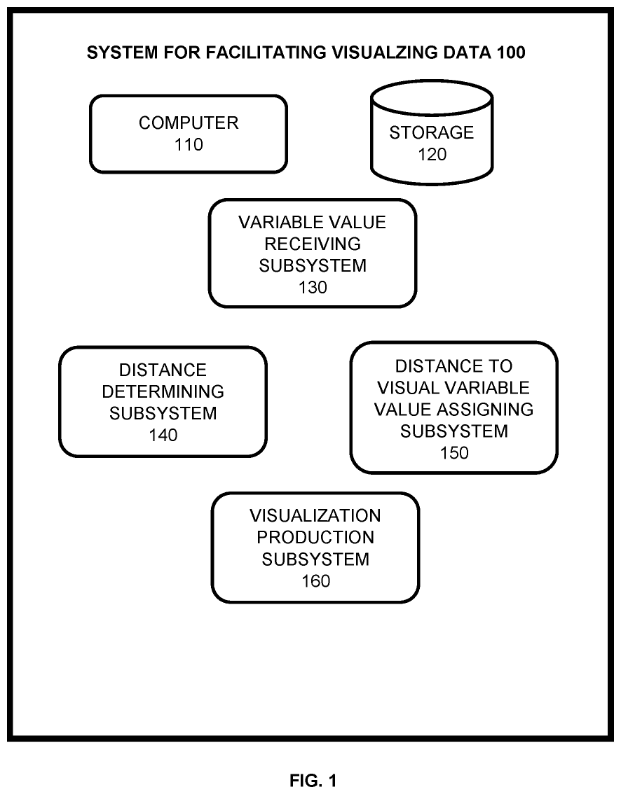

FIG. 1 shows an example system for facilitating visualizing data in accordance with an embodiment of the subject matter. System for facilitating visualizing data 100 (henceforth system 100) is an example of a system implemented as a computer program on one or more computers in one or more locations (shown collectively as computer 110), with one or more storage devices in one or more locations (shown collectively as storage 120), in which the systems, components, and techniques described below can be implemented. A computer can include a display that can display visualizations as described above.

System 100 activates variable value receiving subsystem 130 for receiving a value of a variable. Next, system 100 activates distance determining subsystem 140 for determining a distance to a cluster based on a difference between the value of the variable and a most likely value of the variable associated with the cluster, where the most likely value of the variable is based on a plurality of values of the variable. The plurality of values of the variable correspond to a particular column associated with the variable over two or more rows of the data. Next, system 100 activates distance to visual variable assigning subsystem 150, which assigns the distance to a value of a visual variable. Subsequently, system 100 activates visualization production system 160, which produces a visualization that indicates the value of the visual variable. This production can involve plotting the visual variables on a one, two, and three-dimensional display. This production can also involve animating the plot over time.

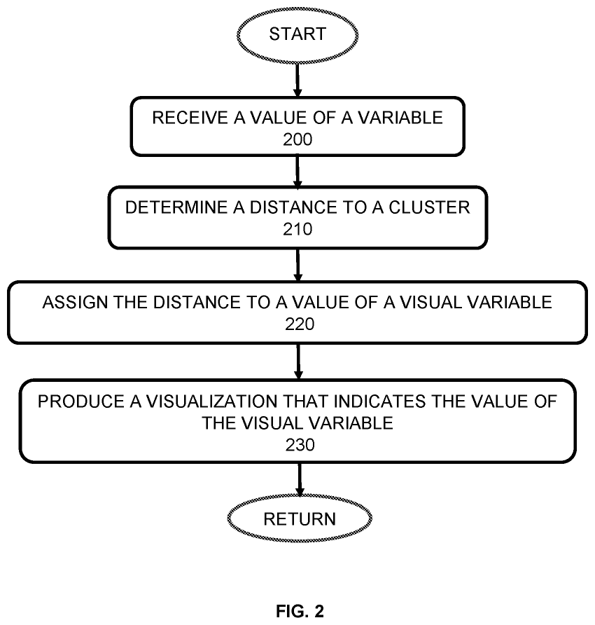

FIG. 2 presents a flow diagram of an example process for facilitating visualizing data. For convenience, the process shown in FIG. 2 will be described as being performed by a system of one or more computers located in one or more locations. During operation, the system performs the following steps.

First, the system receives a value of a variable 200. Next, the system determines a distance to a cluster 210 based on the value of the variable based on a difference between the value of the variable and a most likely value of the variable associated with the cluster, where the most likely value of the variable is based on a plurality of values of the variable. Subsequently, the system assigns the distance to a value of a visual variable 220. Next, the system produces a visualization that indicates the value of the visual variable 230.

The system can receive the value of the variable, transmit to subsystems, and produce a result that indicates the visualization through a communication system, which can be any known or later developed device or system for connecting a computer to a receiver, including a direct cable connection, a connection over a wide area network or a local area network, a connection over an intranet, a connection over the Internet, or a connection over any other distributed processing network or system. Further, the communication links can be wired or wireless links to a network. The network can be a local area network, a wide area network, an intranet, the Internet, or any other distributed processing and storage network. Moreover, components of the system can be interconnected by any form or medium of digital data communication, e.g., a communication network. Examples of communication networks include a local area network (“LAN”) and a wide area network (“WAN”), e.g., the Internet.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system’ encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

The descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

1. A computer-implemented method for facilitating visualizing data, comprising:
receiving a value of a variable;
determining a distance to a first cluster based on the value of the variable;
determining a distance to a second cluster based on the value of the variable; and
plotting the variable on a graph with coordinates comprising the distance to the first cluster and the distance to the second cluster.

2. The method of claim 1,
wherein determining a distance to a cluster is additionally based on a variance of the variable, and
wherein the variance is based on the plurality of values of the variable.

3. The method of claim 2,
wherein the variance is based on a multiplicative identity.

4. The method of claim 1,
wherein determining a distance to a cluster is additionally based on a probability, and
wherein the probability is based on the plurality of values of the variable.

5. The method of claim 1,
wherein the first cluster is selected based on visual importance.

6. The method of claim 1,
wherein the first cluster is selected based on a variance of the distance to the cluster, and
wherein the variance of the distance to the first cluster is based on a plurality of distances to the first cluster.

7. One or more non-transitory computer-readable storage media storing instructions that when executed by one or more computers cause the one or more computers to perform operations for facilitating visualizing data, comprising:
receiving a value of a variable;
determining a distance to a first cluster based on the value of the variable;
determining a distance to a second cluster based on the value of the variable;
plotting the variable on a graph with coordinates comprising the distance to the first cluster and the distance to the second cluster.

8. The one or more non-transitory computer-readable storage media of claim 7,
wherein determining a distance to a cluster is additionally based on a variance of the variable, and
wherein the variance is based on the plurality of values of the variable.

9. The one or more non-transitory computer-readable storage media of claim 8,
wherein the variance is based on a multiplicative identity.

10. The one or more non-transitory computer-readable storage media of claim 7,
wherein determining a distance to a cluster is additionally based on a probability, and
wherein the probability is based on the plurality of values of the variable.

11. The method of claim 7,
wherein the first cluster is selected based on visual importance.

12. The method of claim 7,
wherein the first cluster is selected based on a variance of the distance to the first cluster, and
wherein the variance of the distance to the first cluster is based on a plurality of distances to the first cluster.

13. A system comprising one or more computers and one or more storage devices storing instructions that when executed by the one or more computers cause the one or more computers to perform operations for facilitating visualizing data, comprising:
receiving a value of a variable;
determining a distance to a first cluster based on the value of the variable;
determining a distance to a second cluster based on the value of the variable; and
plotting the variable on a graph with coordinates comprising the distance to the first cluster and the distance to the second cluster.

14. The system of claim 13,
wherein determining a distance to a cluster is additionally based on a variance of the variable, and
wherein the variance is based on the plurality of values of the variable.

15. The system of claim 14,
wherein the variance is based on a multiplicative identity.

16. The system of claim 14,
wherein determining a distance to a cluster is additionally based on a probability, and
wherein the probability is based on the plurality of values of the variable.

17. The system of claim 13,
wherein the first cluster is selected based on visual importance.

18. The system of claim 13,
wherein the first cluster is selected based on a variance of the distance to the first cluster, and
wherein the variance of the distance to the first cluster is based on a plurality of distances to the first cluster.
